(19) United States
(12) Patent Application Publication
(10) Pub. No.: US 2024/0396408 A1
(43) Pub. Date: Nov. 28, 2024

(54) STATOR FOR ROTATING ELECTRIC MACHINE

(71) Applicant: KABUSHIKI KAISHA TOYOTA JIDOSHOKKI, Aichi-ken (JP)

(72) Inventors: Noriyuki SUZUKI, Kariya-shi (JP); Tomohiko YOSHIMURA, Kariya-shi (JP)

(73) Assignee: KABUSHIKI KAISHA TOYOTA JIDOSHOKKI, Aichi-ken (JP)

(21) Appl. No.: 18/651,982

(22) Filed: May 1, 2024

(30) Foreign Application Priority Data
May 24, 2023 (JP) 2023-085577

(51) Int. Cl. H02K 11/25; F25B 31/02; H02K 1/14

(52) U.S. Cl. CPC H02K 11/25; F25B 31/026; H02K 1/146

(57) ABSTRACT

A stator includes a stator core, coils, and a thermistor. The stator core includes a cylindrical yoke and multiple teeth extending from an inner circumferential surface of the yoke. The stator core includes slots each located between adjacent ones of the teeth in a circumferential direction of the yoke. The thermistor is configured to measure a temperature of the coils. A pillar-shaped insulating member is disposed in each slot. The insulating member is disposed in each slot between the coils, which are adjacent to each other in the circumferential direction. At least one of the insulating members includes a thermistor insertion hole that opens in an end face at an end in a lengthwise direction of the insulating member. The thermistor is held by the corresponding insulating member in a state of being inserted in the thermistor insertion hole.

### CROSS-REFERENCE TO RELATED APPLICATION

This application is based upon and claims the benefit of priority from prior Japanese Patent Application No. 2023-085577, filed on May 24, 2023, the entire contents of which are incorporated herein by reference.

### BACKGROUND

### 1. Field

The present disclosure relates to a stator for a rotating electric machine.

### 2. Description of Related Art

Japanese Laid-Open Patent Publication No. 2019-126251 discloses a stator of a rotating electric machine that includes a stator core and coils. The stator core includes a cylindrical yoke and multiple teeth. The teeth extend from the inner circumferential surface of the yoke. The stator core includes slots each located between two teeth that are adjacent to each other in the circumferential direction of a yoke. Each coil is formed by a winding that is wound in a concentrated manner around the corresponding tooth while passing through the corresponding slots. Each tooth includes a tooth extension and two flanges. The tooth extension extends from the inner circumferential surface of the yoke. The two flanges project from the distal end of the tooth extension toward opposite sides in the circumferential direction of the yoke.

The stator of such a rotating electric machine may include a thermistor that measures the temperature of the coils. However, if the position of the thermistor relative to the coils is unstable, it may be difficult to accurately measure the temperature of the coils using the thermistor.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a stator for a rotating electric machine includes a stator core, multiple coils, and a thermistor. The stator core includes a cylindrical yoke and multiple teeth extending from an inner circumferential surface of the yoke. The stator core includes slots each located between adjacent ones of the teeth in a circumferential direction of the yoke. Each coil is formed by a winding that is wound in a concentrated manner around the corresponding one of the teeth while passing through the corresponding slots. The thermistor is configured to measure a temperature of the coils. A pillar-shaped insulating member is disposed in each slot. The insulating member is located between the coils that are adjacent to each other in the circumferential direction in the slot. At least one of the insulating members includes a thermistor insertion hole that opens in an end face at an end in a lengthwise direction of the insulating member. The thermistor is held by the corresponding insulating member in a state of being inserted in the thermistor insertion hole.

Other features and aspects will be apparent from the following detailed description, the drawings, and the claims.

### BRIEF DESCRIPTION OF THE DRAWINGS

FIG. 1 is a cross-sectional view of a motor-driven compressor according to an embodiment.

FIG. 2 is a perspective view of the stator shown in FIG. 1.

FIG. 3 is a cross-sectional view of the stator shown in FIG. 2.

FIG. 4 is an enlarged cross-sectional view of a portion of the stator shown in FIG. 2.

FIG. 5 is an enlarged perspective view of a portion of the stator shown in FIG. 2.

FIG. 6 is a cross-sectional view showing a relationship between an insulating member and a thermistor shown in FIG. 5.

FIG. 7 is a perspective view showing a portion of the insulating member shown in FIG. 5.

FIG. 8 is a cross-sectional view showing a relationship between the insulating member shown in FIG. 5, a thermistor, and plastic.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

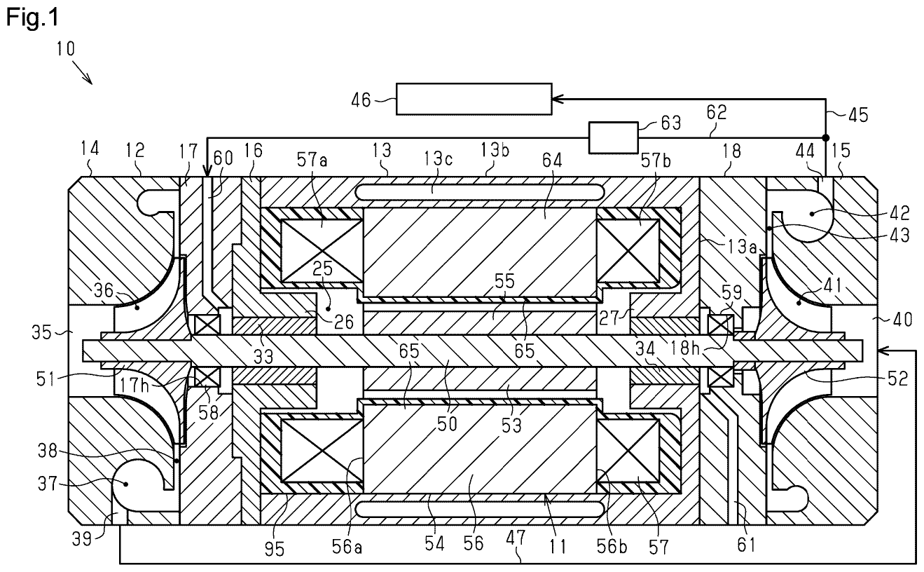

A stator 54 for a rotating electric machine 11 according to one embodiment will now be described with reference to FIGS. 1 to 8. The stator 54 for the rotating electric machine 11 of the present embodiment is part of a motor-driven compressor 10. The motor-driven compressor 10 is a centrifugal compressor mounted on a fuel cell electric vehicle. The motor-driven compressor 10 compresses air, which is fluid.

### Basic Configuration of Motor-Driven Compressor

As shown in FIG. 1, the motor-driven compressor 10 includes the rotating electric machine 11 and a housing 12. The housing 12 includes a motor housing member 13, a first compressor housing member 14, a second compressor housing member 15, a first plate 16, a second plate 17, and a third plate 18. The motor housing member 13, the first compressor housing member 14, the second compressor housing member 15, the first plate 16, the second plate 17, and the third plate 18 are made of metal. The motor housing member 13, the first compressor housing member 14, the second compressor housing member 15, the first plate 16, the second plate 17, and the third plate 18 are made of, for example, aluminum.

The motor housing member 13 includes an end wall 13a and a peripheral wall 13b. The end wall 13a is, for example, disc-shaped. The peripheral wall 13b cylindrically extends from the outer periphery of the end wall 13a. The peripheral wall 13b includes a coolant passage 13c. The peripheral wall 13b of the motor housing member 13 is cooled by the coolant flowing through the coolant passage 13c.

The first plate 16 is, for example, disc-shaped. The first plate 16 closes an opening of the peripheral wall 13b of the motor housing member 13. The motor housing member 13 and the first plate 16 define a motor chamber 25. The housing 12 thus defines the motor chamber 25. The motor chamber 25 accommodates the rotating electric machine 11. The housing 12 thus accommodates the rotating electric machine 11.

The housing 12 includes a first bearing holding portion 26. The first bearing holding portion 26 projects from a center portion of the first plate 16 into the motor chamber 25. The first bearing holding portion 26 is cylindrical. The axis of the first bearing holding portion 26 agrees with the axis of the peripheral wall 13b. The first bearing holding portion 26 includes a through-hole. The through-hole of the first bearing holding portion 26 extends through the first plate 16 and opens in an end face of the first plate 16 on a side opposite to the motor housing member 13.

The housing 12 includes a second bearing holding portion 27. The second bearing holding portion 27 projects from a center portion of the end wall 13a of the motor housing member 13 into the motor chamber 25. The second bearing holding portion 27 is cylindrical. The axis of the second bearing holding portion 27 agrees with the axis of the peripheral wall 13b. Accordingly, the axis of the first bearing holding portion 26 and the axis of the second bearing holding portion 27 agree with each other. The second bearing holding portion 27 includes a through-hole. The through-hole of the second bearing holding portion 27 extends through the end wall 13a of the motor housing member 13 and opens in an end face of the end wall 13a on a side opposite to the peripheral wall 13b.

The second plate 17 is coupled to an end face of the first plate 16 on a side opposite to the motor housing member 13. The second plate 17 is attached to the first plate 16 with the thickness direction of the second plate 17 agreeing with the thickness direction of the first plate 16.

The second plate 17 includes a first insertion hole 17h. The first insertion hole 17h extends through a center portion of the second plate 17. The first insertion hole 17h is continuous with the through-hole of the first bearing holding portion 26. The axis of the first insertion hole 17h agrees with the axis of the first bearing holding portion 26.

The third plate 18 is coupled to an end face of the end wall 13a of the motor housing member 13 on a side opposite to the peripheral wall 13b. The third plate 18 is attached to the end wall 13a of the motor housing member 13 in a state in which the thickness direction of the third plate 18 agrees with the thickness direction of the end wall 13a of the motor housing member 13.

The third plate 18 includes a second insertion hole 18h. The second insertion hole 18h extends through a center portion of the third plate 18. The second insertion hole 18h is continuous with the through-hole of the second bearing holding portion 27. The axis of the second insertion hole 18h agrees with the axis of the second bearing holding portion 27.

The first compressor housing member 14 is tubular and includes a first suction port 35, which is a circular hole into which air is drawn. The first compressor housing member 14 is coupled to an end face of the second plate 17 on a side opposite to the first plate 16 in a state in which the axis of the first suction port 35 agrees with the axis of the first insertion hole 17h. The first suction port 35 opens in an end face of the first compressor housing member 14 on a side opposite to the second plate 17. Air that has been cleaned by an air cleaner (not shown) flows through the first suction port 35.

The motor-driven compressor 10 includes a first impeller chamber 36, a first discharge chamber 37, and a first diffuser passage 38. The first impeller chamber 36, the first discharge chamber 37, and the first diffuser passage 38 are provided between the first compressor housing member 14 and the second plate 17. The first impeller chamber 36 is continuous with the first suction port 35. The first discharge chamber 37 is located around the first impeller chamber 36 and extends about the axis of the first suction port 35. The first diffuser passage 38 connects the first impeller chamber 36 and the first discharge chamber 37 to each other. The first impeller chamber 36 is continuous with the first insertion hole 17h.

The motor-driven compressor 10 includes a first discharge passage 39. The first discharge passage 39 is formed in the first compressor housing member 14. A first end of the first discharge passage 39 is continuous with the first discharge chamber 37. A second end of the first discharge passage 39 opens in the outer peripheral surface of the first compressor housing member 14.

The second compressor housing member 15 is tubular and includes a second suction port 40, which is a circular hole into which air is drawn. The second compressor housing member 15 is coupled to an end face of the third plate 18 on a side opposite to the motor housing member 13 in a state in which the axis of the second suction port 40 agrees with the axis of the second insertion hole 18h. The second suction port 40 opens in an end face of the second compressor housing member 15 on a side opposite to the third plate 18.

The motor-driven compressor 10 includes a second impeller chamber 41, a second discharge chamber 42, and a second diffuser passage 43. The second impeller chamber 41, the second discharge chamber 42, and the second diffuser passage 43 are provided between the second compressor housing member 15 and the third plate 18. The second impeller chamber 41 is continuous with the second suction port 40. The second discharge chamber 42 is located around the second impeller chamber 41 and extends about the axis of the second suction port 40. The second diffuser passage 43 connects the second impeller chamber 41 and the second discharge chamber 42 to each other. The second impeller chamber 41 is continuous with the second insertion hole 18h.

The motor-driven compressor 10 includes a second discharge passage 44. The second discharge passage 44 is formed in the second compressor housing member 15. A first end of the second discharge passage 44 is continuous with the second discharge chamber 42. A second end of the second discharge passage 44 opens in the outer peripheral surface of the second compressor housing member 15.

A supply pipe 45 is connected to the second discharge passage 44. The supply pipe 45 is connected to a fuel cell stack 46. A first end of the supply pipe 45 is connected to the second discharge passage 44. A second end of the supply pipe 45 is connected to the fuel cell stack 46.

The motor-driven compressor 10 includes a connection pipe 47. A first end of the connection pipe 47 is connected to the first discharge passage 39. A second end of the connection pipe 47 is connected to the second suction port 40. Air discharged from the first discharge chamber 37 to the first discharge passage 39 flows through the connection pipe 47. The air that has passed through the connection pipe 47 is drawn into the second impeller chamber 41 through the second suction port 40.

The motor-driven compressor 10 includes a rotary shaft 50. The rotary shaft 50 extends across the motor chamber 25 in a state in which the axis of the rotary shaft 50 and the axis of the peripheral wall 13b agree with each other. A first end in the axial direction of the rotary shaft 50 projects into the first impeller chamber 36 from the inside of the motor chamber 25, through the through-hole of the first bearing holding portion 26 and the first insertion hole 17h. A second end in the axial direction of the rotary shaft 50 projects into the second impeller chamber 41 from the inside of the motor chamber 25, through the through-hole of the second bearing holding portion 27 and the second insertion hole 18h.

The motor-driven compressor 10 includes a first impeller 51 and a second impeller 52. The first impeller 51 is coupled to the first end of the rotary shaft 50. The first impeller 51 is accommodated in the first impeller chamber 36. The first impeller chamber 36 thus accommodates the first impeller 51. The first impeller 51 rotates integrally with the rotary shaft 50 to compress air drawn into the first impeller chamber 36.

The second impeller 52 is coupled to the second end of the rotary shaft 50. The second impeller 52 is accommodated in the second impeller chamber 41. The second impeller chamber 41 thus accommodates the second impeller 52. The second impeller 52 rotates integrally with the rotary shaft 50 to compress air drawn into the second impeller chamber 41. The second impeller 52 rotates to compress the air that has been compressed by the first impeller 51.

As described above, the first impeller 51 and the second impeller 52 rotate integrally with the rotary shaft 50. The first impeller 51 and the second impeller 52 form a compression mechanism that is driven by rotation of the rotary shaft 50 to compress air.

The rotating electric machine 11 includes a rotor 53 and the stator 54. The rotor 53 is fixed to the rotary shaft 50. The rotor 53 includes a cylindrical rotor core 55, which is fixed to the rotary shaft 50, and permanent magnets (not shown), which are provided in the rotor core 55. The rotor 53 rotates integrally with the rotary shaft 50.

The stator 54 is fixed to the housing 12. The stator 54 is disposed at a radially outer side of the rotor 53. The stator 54 includes a cylindrical stator core 56 and coils 57.

The stator core 56 is fixed to the inner circumferential surface of the peripheral wall 13b of the motor housing member 13. The stator core 56 includes a first end face 56a and a second end face 56b, which is located on a side opposite to the first end face 56a in the axial direction. The stator core 56 is disposed in the motor chamber 25 such that the first end face 56a faces the first plate 16 in the axial direction of the rotary shaft 50, and the second end face 56b faces the end wall 13a of the motor housing member 13 in the axial direction of the rotary shaft 50.

The coils 57 are installed in the stator core 56 in a wound state. The stator 54 includes first coil ends 57a and second coil ends 57b. The first coil ends 57a and the second coil ends 57b are parts of the coils 57. The first coil ends 57a project from the first end face 56a, which is an end face of the stator core 56, toward the first plate 16. The second coil ends 57b project from the second end face 56b, which is an end face of the stator core 56, toward the end wall 13a of the motor housing member 13.

The rotary shaft 50 rotates integrally with the rotor 53 when current flows through the coils 57 from a battery (not shown). The rotating electric machine 11 thus rotates the rotary shaft 50.

The motor-driven compressor 10 includes a first bearing 33 and a second bearing 34. The first bearing 33 is cylindrical. The first bearing 33 is a dynamic plain bearing. The first bearing 33 is held by the first bearing holding portion 26. The first bearing 33 supports the rotary shaft 50 such that the rotary shaft 50 is rotatable with respect to the first plate 16.

The second bearing 34 is cylindrical. The second bearing 34 is a dynamic plain bearing. The second bearing 34 is held by the second bearing holding portion 27. The second bearing 34 supports the rotary shaft 50 such that the rotary shaft 50 is rotatable with respect to the end wall 13a of the motor housing member 13. In this manner, the rotary shaft 50 is rotationally supported by the housing 12 with the first bearing 33 and the second bearing 34.

The motor-driven compressor 10 includes a first seal member 58. The first seal member 58 is provided between the inner peripheral surface of the first insertion hole 17h and the rotary shaft 50. The first seal member 58 restricts air leakage to the motor chamber 25 from the first impeller chamber 36 via the first insertion hole 17h and the through-hole of the first bearing holding portion 26. The first seal member 58 is, for example, a seal ring.

The motor-driven compressor 10 includes a second seal member 59. The second seal member 59 is provided between the inner circumferential surface of the second insertion hole 18h and the rotary shaft 50. The second seal member 59 restricts air leakage to the motor chamber 25 from the second impeller chamber 41 via the second insertion hole 18h and the through-hole of the second bearing holding portion 27. The second seal member 59 is, for example, a seal ring.

The air drawn into the first impeller chamber 36 through the first suction port 35 is delivered to the first diffuser passage 38 while being accelerated by rotation of the first impeller 51, and is then pressurized by passing through the first diffuser passage 38. The air that has passed through the first diffuser passage 38 is discharged to the first discharge chamber 37. The air discharged to the first discharge chamber 37 is discharged to the first discharge passage 39. The air discharged to the first discharge passage 39 is drawn into the second impeller chamber 41 through the connection pipe 47 and the second suction port 40. The air drawn into the second impeller chamber 41 is delivered to the second diffuser passage 43 while being accelerated by rotation of the second impeller 52, and is then pressurized by passing through the second diffuser passage 43. The air that has passed through the second diffuser passage 43 is discharged to the second discharge chamber 42. The air discharged to the second discharge chamber 42 is discharged to the second discharge passage 44. The air discharged to the second discharge passage 44 is supplied to the fuel cell stack 46 via the supply pipe 45. The motor-driven compressor 10 thus supplies air to the fuel cell stack 46. Oxygen contained in the air supplied to the fuel cell stack 46 contributes to power generation in the fuel cell stack 46.

The motor-driven compressor 10 includes an inflow passage 60. The inflow passage 60 is formed in the second plate 17. A first end of the inflow passage 60 opens in the outer circumferential surface of the second plate 17. A second end of the inflow passage 60 is continuous with a section of the first insertion hole 17h between the first seal member 58 and the motor chamber 25.

The motor-driven compressor 10 includes an outflow passage 61. The outflow passage 61 is formed in the third plate 18. A first end of the outflow passage 61 is connected to a section of the second insertion hole 18h that is closer to the motor chamber 25 than the second seal member 59 is. A second end of the outflow passage 61 opens in the outer circumferential surface of the third plate 18.

A branch pipe 62 is connected to the first end of the inflow passage 60. The branch pipe 62 branches from the middle of the supply pipe 45. A first end of the branch pipe 62 is connected to the supply pipe 45. A second end of the branch pipe 62 is connected to the first end of the inflow passage 60. An intercooler 63 is provided in the branch pipe 62. The intercooler 63 cools air flowing through the branch pipe 62.

Some of the air flowing through the supply pipe 45 flows into the branch pipe 62. The air flowing through the branch pipe 62 is cooled by the intercooler 63. The air that has passed through the intercooler 63 therefore has a temperature lower than the temperature of the air discharged into the second discharge chamber 42. The air cooled by the intercooler 63 is drawn into the motor chamber 25 through the inflow passage 60, the first insertion hole 17h, and the through-hole of the first bearing holding portion 26. The inflow passage 60 thus draws air into the motor chamber 25.

The first bearing 33 is cooled by air that passes through the through-hole of the first bearing holding portion 26. The rotating electric machine 11 is cooled by the air drawn into the motor chamber 25. The air drawn into the motor chamber 25 flows through the gap between the stator 54 and the rotor 53 and flows through the through-hole of the second bearing holding portion 27. The second bearing 34 is cooled by air that passes through the through-hole of the second bearing holding portion 27. The air that has passed through the through-hole of the second bearing holding portion 27 is discharged to the outside via the second insertion hole 18h and the outflow passage 61.

### Stator

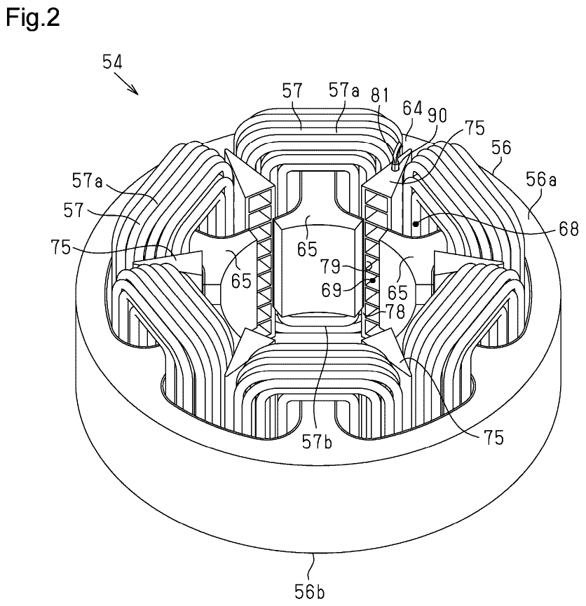

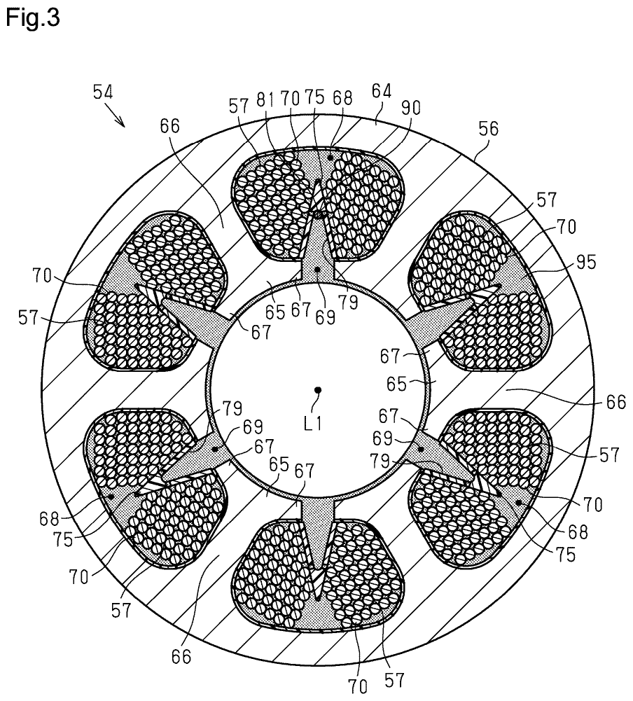

As shown in FIGS. 2 and 3, the stator core 56 includes a cylindrical yoke 64 and multiple teeth 65. Each tooth 65 extends from the inner circumferential surface of the yoke 64. The teeth 65 are spaced apart from each other in the circumferential direction of the yoke 64. Specifically, the teeth 65 are disposed at equal intervals in the circumferential direction of the yoke 64. Each tooth 65 extends from the inner circumferential surface of the yoke 64 toward an axis L1 of the stator core 56. The distal surface of each tooth 65 at the side opposite to the yoke 64 is an arcuate surface, which is curved arcuately. The distal surfaces of the teeth 65 are located on a concentric circle.

In the axial direction of the stator core 56, the yoke 64 includes a first end face and a second end face, which are flat surfaces. In the axial direction of the stator core 56, each tooth 65 includes a first end face and a second end face, which are flat surfaces. The length of the yoke 64 in the axial direction of the stator core 56 is equal to the length of each tooth 65 in the axial direction of the stator core 56. The first end face of the yoke 64 and the first end face of each tooth 65 are located on the same plane. The second end face of the yoke 64 and the second end face of each tooth 65 are located on the same plane. The first end face of the yoke 64 and the first end faces of the teeth 65 form a first end face 56a of the stator core 56. The second end face of the yoke 64 and the second end faces of the teeth 65 form a second end face 56b of the stator core 56.

As shown in FIG. 3, each tooth 65 includes a tooth extension 66 and two flanges 67. The tooth extension 66 extends from the inner circumferential surface of the yoke 64. The tooth extension 66 is a section of each tooth 65 that extends from the inner circumferential surface of the yoke 64. The two flanges 67 project from the distal end of the tooth extension 66 toward opposite sides in the circumferential direction of the yoke 64.

The stator core 56 includes slots 68 each located between two of the teeth 65 that are adjacent to each other in the circumferential direction of the yoke 64. A slot opening 69, which is the gap between two of the flanges 67 adjacent to each other in the circumferential direction of the yoke 64, is continuous with the corresponding slot 68. Each slot opening 69 is a space between distal ends of adjacent ones of the flanges 67 in the circumferential direction of the yoke 64. Each coil 57 is formed by a winding 70 that is wound in a concentrated manner around the corresponding tooth 65 while passing through the corresponding slots 68. The coils 57 are thus partially located in the slots 68.

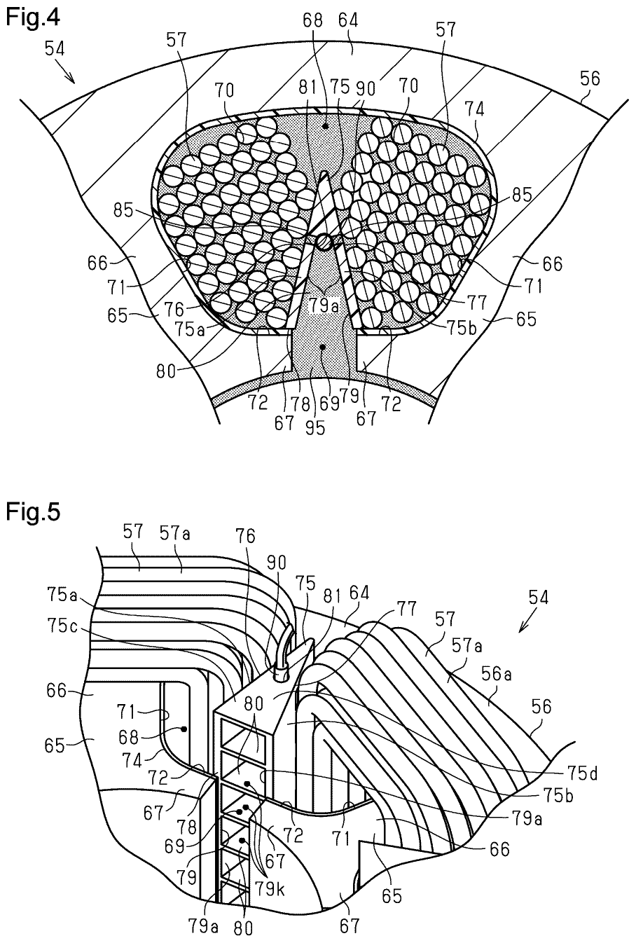

As shown in FIG. 4, each tooth extension 66 includes two tooth side surfaces 71. The two tooth side surfaces 71 are located on opposite sides of the tooth extension 66 in the circumferential direction of the yoke 64. The tooth side surfaces 71 are continuous with the inner circumferential surface of the yoke 64. The tooth side surfaces 71 define the slots 68. Each flange 67 includes a flange surface 72. Each flange surface 72 is continuous with an end of the tooth side surface 71 opposite to the inner circumferential surface of the yoke 64. Each flange surface 72 extends from the corresponding tooth side surface 71 to the distal end of the flange 67. The flange surfaces 72 define the slots 68. Each slot 68 is a space defined by a part of the inner circumferential surface of the yoke 64, two of the tooth side surfaces 71, and two of the flange surfaces 72.

The stator 54 includes slot insulating sheets 74. The slot insulating sheets 74 are respectively inserted into the slots 68. Each slot insulating sheet 74 is disposed between the corresponding coils 57 and the stator core 56. The slot insulating sheet 74 insulates the stator core 56 from sections of the coils 57 arranged in the slot 68. The slot insulating sheet 74 is an elongated sheet that is curved in the shape of U in a transverse direction. The slot insulating sheet 74 is inserted into the slot 68 with the lengthwise direction agreeing with the axial direction of the stator core 56. The slot insulating sheet 74 extends along part of the inner circumferential surface of the yoke 64, the two tooth side surfaces 71, and the two flange surfaces 72, which define the slot 68. The slot insulating sheet 74 extends from a first end to a second end in the axial direction of the stator core 56.

### Insulating Members

As shown in FIGS. 2 and 3, an insulating member 75 is disposed in each slot 68. The insulating members 75 each have the shape of a triangular prism. The insulating members 75 are made of plastic. Each insulating member 75 is located in one of the slots 68 and between the coils 57, which are adjacent to each other in the circumferential direction of the yoke 64. The insulating member 75 insulates the coils 57, adjacent to each other in the circumferential direction of the yoke 64, from each other in the slot 68. The insulating member 75 is disposed in the slot 68 with the lengthwise direction of the insulating member 75 agreeing with the axial direction of the stator core 56.

As shown in FIG. 2, the opposite ends in the lengthwise direction of the insulating member 75 respectively project from the first end face 56a and the second end face 56b of the stator core 56. Thus, the length of the insulating member 75 in the lengthwise direction is longer than the length of the stator core 56 in the axial direction. A portion of the insulating member 75 that protrudes from the first end face 56a of the stator core 56 is a first protruding portion of the insulating member 75. A portion of the insulating member 75 that protrudes from the second end face 56b of the stator core 56 is a second protruding portion of the insulating member 75.

The first protruding portion of the insulating member 75 is disposed between the first coil ends 57a adjacent to each other in the circumferential direction of the yoke 64. The first protruding portion of the insulating member 75 insulates the first coil ends 57a adjacent to each other in the circumferential direction of the yoke 64 from each other. In this manner, the first protruding portion of the insulating member 75 protrudes from the first end face 56a of the stator core 56 and is disposed between the first coil ends 57a adjacent to each other in the circumferential direction of the yoke 64.

The second protruding portion of the insulating member 75 is disposed between the second coil ends 57b adjacent to each other in the circumferential direction of the yoke 64. The second protruding portion of the insulating member 75 insulates the second coil ends 57b adjacent to each other in the circumferential direction of the yoke 64 from each other. In this manner, the second protruding portion of the insulating member 75 protrudes from the second end face 56b of the stator core 56 and is disposed between the second coil ends 57b adjacent to each other in the circumferential direction of the yoke 64.

As shown in FIG. 4, each insulating member 75 includes a first coil supporting surface 76 and a second coil supporting surface 77. The first coil supporting surface 76 is adjacent to one of the two coils 57 that are adjacent to each other in the circumferential direction of the yoke 64. The second coil supporting surface 77 is adjacent to the other one of the two coils 57 that are adjacent to each other in the circumferential direction of the yoke 64.

The first coil supporting surface 76 supports one of the two coils 57 that are adjacent to each other in the circumferential direction of the yoke 64. The first coil supporting surface 76 is in contact with one of the two coils 57 that are adjacent to each other in the circumferential direction of the yoke 64. The second coil supporting surface 77 supports the other one of the two coils 57 that are adjacent to each other in the circumferential direction of the yoke 64. The second coil supporting surface 77 is in contact with the other one of the two coils 57 that are adjacent to each other in the circumferential direction of the yoke 64. The first coil supporting surface 76 and the second coil supporting surface 77 extend toward the inner circumferential surface of the yoke 64 from the flange surfaces 72 of the flanges 67 of the teeth 65, around which the windings 70 of the corresponding coils 57 are wound. The distance between the first coil supporting surface 76 and the second coil supporting surface 77 decreases toward the inner circumferential surface of the yoke 64.

Each insulating member 75 includes a supported surface 78. The supported surface 78 extends over the corresponding slot opening 69 and is supported by both of the corresponding flanges 67 that are adjacent to each other in the circumferential direction of the yoke 64. The supported surface 78 connects an end of the first coil supporting surface 76 located at a side opposite to the inner circumferential surface of the yoke 64 to an end of the second coil supporting surface 77 located at a side opposite to the inner circumferential surface of the yoke 64. The supported surface 78 is flat. The supported surface 78 includes parts each extending along the associated flange surface 72. The supported surface 78 is supported by the flanges 67 with the slot insulating sheet 74 located in between.

As shown in FIG. 2, the supported surface 78 includes a body portion, which is located in the slot 68, and a first protruding portion, and a second protruding portion. The first protruding portion and the second protruding portion protrude from the first end face 56a and the second end face 56b of the stator core 56, respectively. A recess 79 is formed in the supported surface 78. The recess 79 extends from the body portion of the supported surface 78 to the first protruding portion and the second protruding portion of the supported surface 78. The recess 79 extends over the entire length of the supported surface 78, that is, from the first protruding portion to the second protruding portion. The recess 79 extends in the lengthwise direction of the insulating member 75. The recess 79 is open toward the slot opening 69. The portion of the recess 79 located in the slot 68 is open toward the slot opening 69.

As shown in FIG. 4, one of two inner surfaces 79a of the recess 79, which are located at opposite sides in the circumferential direction of the yoke 64, extends along the first coil supporting surface 76. The other one of the inner surfaces 79a of the recess 79, which are located at opposite sides in the circumferential direction of the yoke 64, extends along the second coil supporting surface 77. The insulating member 75 includes a first wall 75a that defines the first coil supporting surface 76 and one of the inner surfaces 79a of the recess 79, which extends along the first coil supporting surface 76. The insulating member 75 also includes a second wall 75b that defines the second coil supporting surface 77 and the other one of the inner surfaces 79a of the recess 79, which extends along the second coil supporting surface 77.

As shown in FIG. 5, each insulating member 75 includes multiple ribs 80. The ribs 80 connect the inner surfaces 79a of the recess 79 located on the opposite sides in the circumferential direction of the yoke 64 to each other. The ribs 80 are triangular plates. Each rib 80 has the shape of a thin plate. The ribs 80 connect the inner surfaces 79a of the recess 79 located on the opposite sides in the circumferential direction of the yoke 64 to each other in a state in which the thickness direction of each rib 80 agrees with the lengthwise direction of the insulating member 75. The ribs 80 are arranged at equal intervals in the lengthwise direction of the insulating member 75. Thus, the distance between adjacent ones of the ribs 80 in the lengthwise direction of the insulating member 75 is constant. The inner space of the recess 79 is partitioned into spaces 79k by the ribs 80 in the lengthwise direction of the insulating member 75.

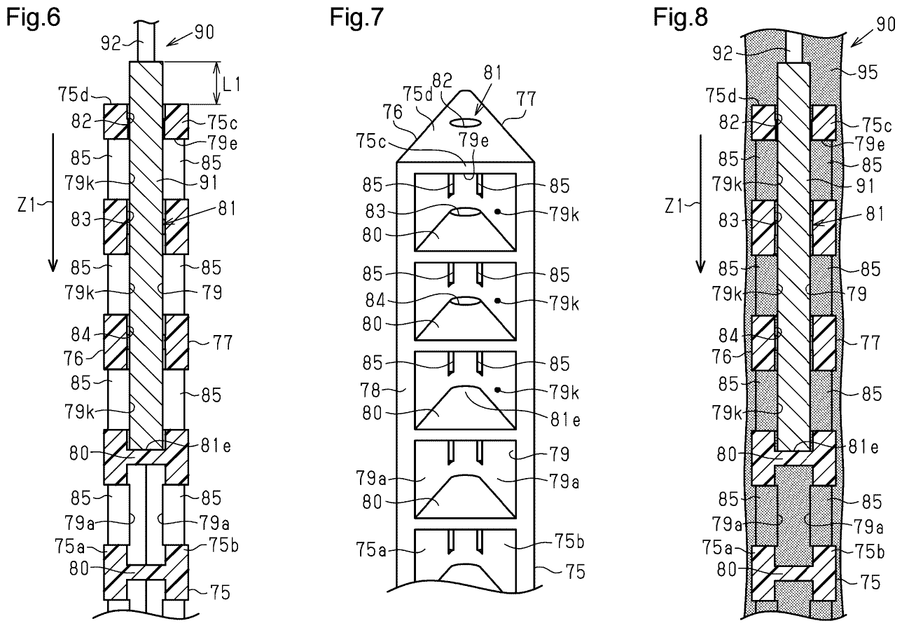

As shown in FIGS. 6 and 7, one of the insulating members 75 includes a thermistor insertion hole 81. The thermistor insertion hole 81 is formed in only one of the insulating members 75. The thermistor insertion hole 81 includes a first hole 82, a second hole 83, and a third hole 84. The first hole 82 extends through an end wall 75c, which is located at one end in the lengthwise direction of the insulating member 75. The end wall 75c includes an inner surface 79e, which defines a recess 79. The first hole 82 opens in the outer surface of the end wall 75c. The outer surface of the end wall 75c is an end face 75d, which is located at one end in the lengthwise direction of the insulating member 75. The first hole 82 thus opens in the end face 75d, which is located at one end in the lengthwise direction of the insulating member 75. Therefore, the thermistor insertion hole 81 opens in the end face 75d at one end in the lengthwise direction of the insulating member 75. The first hole 82 is circular. The first hole 82 opens in a section of the end face 75d of the insulating member 75 that is separated from the supported surface 78.

The second hole 83 extends through a first rib 80, which is one of the ribs 80 that is closest to the end face 75d of the insulating member 75. The second hole 83 is circular. The inner diameter of the second hole 83 is equal to the inner diameter of the first hole 82. The third hole 84 extends through a second rib 80, which is one of the ribs 80 that is second closest to the end face 75d of the insulating member 75. The third hole 84 is circular. The inner diameter of the third hole 84 is equal to the inner diameter of the first hole 82 and the inner diameter of the second hole 83. The axis of the first hole 82, the axis of the second hole 83, and the axis of the third hole 84 agree with one another. The first hole 82, the second hole 83, and the third hole 84 are respectively continuous with the recess 79. The recess 79 is thus continuous with the thermistor insertion hole 81.

The thermistor insertion hole 81, which includes the first hole 82, the second hole 83, and the third hole 84, is disposed at such a position that ensures the minimum thicknesses of the first wall 75a and the second wall 75b required for manufacturing.

The first wall 75a and the second wall 75b each include connection holes 85. The connection holes 85 are respectively provided in the sections of the first wall 75a and the second wall 75b that correspond to each space 79k. Each connection hole 85 opens in the inner surface 79a of the recess 79. The connection holes 85 that are formed in the first wall 75a open in the first coil supporting surface 76. The connection holes 85 that are formed in the second wall 75b open in the second coil supporting surface 77.

As shown in FIG. 4, each connection hole 85 connects the recess 79 to the slot 68. Thus, a connection hole 85 is open in each of the first coil supporting surface 76 and the second coil supporting surface 77 to connect the recess 79 and the slot 68 to each other.

### Thermistor

As shown in FIGS. 5 and 6, the stator 54 includes a thermistor 90. The thermistor 90 measures the temperature of the coils 57. The thermistor 90 includes a sensor unit 91 and a lead wire 92. The sensor unit 91 measures the temperature of the coils 57. The sensor unit 91 is tubular. The lead wire 92 extends from a first end of the sensor unit 91. The lead wire 92 is electrically connected to a controller (not shown). The information related to the temperature of the coils 57, measured by the sensor unit 91, is transmitted to the controller via the lead wire 92.

As shown in FIG. 6, the sensor unit 91 has a second end, which passes through the first hole 82, the second hole 83, and the third hole 84. The sensor unit 91 is inserted into the insulating member 75 until the second end of the sensor unit 91 contacts a third rib 80, which is one of the ribs 80 that is third closest to the end face 75d of the insulating member 75.

The space 79k between the end wall 75c of the insulating member 75 and the first rib 80 forms a part of the thermistor insertion hole 81. The space 79k between the first rib 80 and the second rib 80 also forms a part of the thermistor insertion hole 81. The space 79k between the second rib 80 and the third rib 80 also forms a part of the thermistor insertion hole 81. The third rib 80 includes a hole bottom surface 81e, which faces in a direction opposite to an insertion direction Z1 of the thermistor 90 into the thermistor insertion hole 81. Therefore, the insulating member 75 includes the hole bottom surface 81e, which faces in a direction opposite to the insertion direction Z1 of the thermistor 90 into the thermistor insertion hole 81. The sensor unit 91 protrudes from the end face 75d of the insulating member 75 by a predetermined length L1 when the sensor unit 91 is inserted in the thermistor insertion hole 81 and brought into contact with the hole bottom surface 81e.

### Plastic

As shown in FIG. 1, the housing 12 incorporates plastic 95. The plastic 95 covers the first coil end 57a, the second coil end 57b, and the inner circumferential surfaces of the stator core 56. The plastic 95 is thermally coupled to the housing 12.

As shown in FIGS. 3 and 4, some of the plastic 95 fills the slots 68. The plastic 95 has a higher thermal conductivity than the insulating members 75. Examples of the plastic 95 include a plastic in which ceramic particles or glass fibers are mixed with an epoxy plastic.

As shown in FIG. 4, some of the plastic 95 fills the recesses 79. Therefore, the recesses 79 are filled with the plastic 95, which has a higher thermal conductivity than that of the insulating members 75.

As shown in FIG. 8, some of the plastic 95 fills a space between the sensor unit 91 and the inner surface of the insulating member 75 that defines the first hole 82. Some of the plastic 95 fills a space between the sensor unit 91 and the inner surface of the insulating member 75 that defines the second hole 83. Some of the plastic 95 fills a space between the sensor unit 91 and the inner surface of the insulating member 75 that defines the third hole 84. Thus, the space between the thermistor 90 and the inner surface of the insulating member 75 that defines the thermistor insertion hole 81 is filled with plastic 95. The thermistor 90 is held by the insulating member 75 by the thermistor 90 and the insulating member 75 being in close contact with each other with the plastic 95 in between. In this manner, the thermistor 90 is held by the insulating member 75 in a state of being inserted into the thermistor insertion hole 81.

### Operation of Embodiment

Operation of the embodiment will now be described.

The heat generated by the coils 57 is transferred to the peripheral wall 13b of the motor housing member 13, for example, through the teeth 65 and the yoke 64. The peripheral wall 13b of the motor housing member 13 is cooled by the coolant flowing through the coolant passage 13c. Thus, the heat generated by the coils 57 is efficiently dissipated to the peripheral wall 13b of the motor housing member 13 through the teeth 65 and the yoke 64. Also, the heat generated by the coils 57 is transferred to the housing 12 via the plastic 95 and dissipated to the housing 12. Furthermore, the plastic 95 is cooled by some of the air drawn into the motor chamber 25 from the inflow passage 60. Therefore, the heat generated by the coils 57 is transferred to the plastic 95 and efficiently dissipated.

The sensor unit 91 of the thermistor 90 measures the heat transferred from the coils 57 to the associated insulating member 75. The thermistor 90 is held by the insulating member 75 in a state of being inserted into the thermistor insertion hole 81. This stabilizes the position of the thermistor 90 relative to the coils 57. The temperature of the coils 57 is thus accurately measured by the thermistor 90.

### Advantages of Embodiment

The above-described embodiment has the following advantages.

(1) The thermistor 90 is held by the insulating member 75 in a state of being inserted into the thermistor insertion hole 81. This stabilizes the position of the thermistor 90 relative to the coils 57. The temperature of the coils 57 is thus accurately measured by the thermistor 90.

(2) The space between the thermistor 90 and the inner surface of the insulating member 75 that defines the thermistor insertion hole 81 is filled with plastic 95. With this configuration, the space between the thermistor 90 and the inner surface of the insulating member 75 that defines the thermistor insertion hole 81 is filled with plastic 95. Thus, the heat transferred from the coils 57 to the insulating member 75 is readily transferred to the thermistor 90 via the plastic 95. The temperature of the coils 57 is thus further accurately measured by the thermistor 90.

(3) When inserting the thermistor 90 into the thermistor insertion hole 81, the sensor unit 91 is inserted into the thermistor insertion hole 81 until the sensor unit 91 comes into contact with the hole bottom surface 81e. When the sensor unit 91 comes in contact with hole bottom surface 81e, the sensor unit 91 protrudes from the end face 75d of the insulating member 75 by the predetermined length L1. By visually checking that the sensor unit 91 protrudes from the end face 75d of the insulating member 75 by the predetermined length L1, the operator can readily confirm that the sensor unit 91 is inserted into a predetermined position in the thermistor insertion hole 81. This allows the operator to readily check whether the thermistor 90 is properly inserted into the thermistor insertion hole 81.

(4) The recesses 79 are filled with the plastic 95, which has a higher thermal conductivity than that of the insulating members 75. With this configuration, the heat transferred from the coils 57 to the insulating members 75 is transferred to the plastic 95, which has a higher thermal conductivity than the insulating members 75, and is efficiently dissipated to the plastic 95. This efficiently dissipates the heat generated by the coils 57. As a result, the durability of the thermistor 90 is improved.

(5) The connection hole 85 is open in each of the first coil supporting surface 76 and the second coil supporting surface 77 to connect the recess 79 and the slot 68 to each other. With this configuration, when filling the recess 79 with the plastic 95, the air in the recess 79 is discharged through the connection holes 85 into the slot 68. This prevents air pockets from forming in the recess 79. Further, when the plastic 95 fills the recess 79, some of the plastic 95 that has flowed into the recess 79 flows into the slot 68 via the connection holes 85. This allows the plastic 95 to efficiently flow into the slot 68. Accordingly, the slot 68 is efficiently filled with the plastic 95.

(6) The insulating members 75 each include the ribs 80, which connect the inner surfaces 79a of the recess 79 located on the opposite sides in the circumferential direction of the yoke 64 to each other. This structure increases the rigidity of the insulating member 75 in the circumferential direction of the yoke 64 as compared to a structure in which the insulating member 75 does not include the ribs 80. Therefore, even when the insulating member 75 is sandwiched between the coils 57 that are adjacent to each other in the circumferential direction of the yoke 64 in the slot 68, so that load acts on the insulating members 75 from the coils 57, the original shape of the insulating members 75 is readily maintained.

(7) The heat generated at portions of the coils 57 that are away from the teeth 65 is not readily transferred to the teeth 65. On the other hand, the heat generated at portions of the coils 57 that are away from the teeth 65 is readily transferred to the insulating members 75, which are located closer to the coils 57 than the teeth 65 are. Therefore, the heat generated at the portions of the coils 57 away from the teeth 65 is readily dissipated to the insulating members 75. As a result, the heat generated by the coils 57 is efficiently dissipated.

### Modifications

The above-described embodiment may be modified as follows. The above-described embodiment and the following modifications can be combined as long as the combined modifications remain technically consistent with each other.

In the above-described embodiment, the space between the thermistor 90 and the inner surface of the insulating member 75 that defines the thermistor insertion hole 81 does not necessarily need to be filled with plastic 95. In this case, the thermistor 90 may be in direct contact with the inner surface of the insulating member 75 defining the thermistor insertion hole 81.

In the above-described embodiment, the sensor unit 91 of the thermistor 90 does not necessarily need to protrude from the end face 75d of the insulating member 75 by the predetermined length L1, and the sensor unit 91 may be entirely inserted into the thermistor insertion hole 81.

In the above-described embodiment, the recesses 79 do not necessarily need to be filled with the plastic 95, which has a higher thermal conductivity than that of the insulating members 75.

In the above-described embodiment, the first wall 75a and the second wall 75b do not necessarily need to include multiple connection holes 85. In other words, the connection holes 85 do not necessarily need to open in each of the first coil supporting surface 76 and the second coil supporting surface 77 to connect the recess 79 and the slot 68 to each other.

In the above-described embodiment, the distance between adjacent ones of the ribs 80 in the lengthwise direction of the insulating member 75 does not necessarily need to be constant.

In the above-described embodiment, the number of the ribs 80 is not particularly limited.

In the above-described embodiment, the insulating members 75 do not necessarily need to include the rib 80.

In the above-described embodiment, the recess 79 does not necessarily need to extend from the body portion of the supported surface 78 to the first protruding portion and the second protruding portion of the supported surface 78. In other words, the recess 79 may have any configuration as long as the recess 79 is formed in at least the body portion of the supported surface 78 in the slot 68 to open toward the slot opening 69.

In the above-described embodiment, the supported surface 78 does not necessarily need to include the recess 79.

In the above-described embodiment, the insulating member 75 does not necessarily need to have the shape of a triangular prism. In other words, the insulating member 75 may have any shape as long as the insulating member 75 is pillar-shaped and includes the thermistor insertion hole 81 that opens in the end face 75d of the insulating member 75.

In the above-described embodiment, the supported surface 78 of the insulating member 75 may be supported by the flanges 67 while directly contacting the flanges 67 without the slot insulating sheet 74 in between.

In the above-described embodiment, the motor-driven compressor 10 does not necessarily need to include the second impeller 52.

In the above-described embodiment, the motor-driven compressor 10 may include a turbine wheel in place of the second impeller 52.

In the above-described embodiment, the motor-driven compressor 10 is not limited to a centrifugal type, but may be, for example, a scroll type, a piston type, or a vane type. In other words, the motor-driven compressor 10 may be any type as long as it includes a compression mechanism that is driven by rotation of the rotary shaft 50 to compress fluid.

In the above-described embodiment, the motor-driven compressor 10 does not necessarily need to be mounted on a fuel cell electric vehicle. In other words, the motor-driven compressor 10 is not limited to the one that is mounted on a vehicle.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A stator for a rotating electric machine, the stator comprising:
a stator core including a cylindrical yoke and multiple teeth extending from an inner circumferential surface of the yoke, the stator core including slots each located between adjacent ones of the teeth in a circumferential direction of the yoke;
multiple coils, each coil being formed by a winding that is wound in a concentrated manner around the corresponding one of the teeth while passing through the corresponding slots; and
a thermistor configured to measure a temperature of the coils, wherein
a pillar-shaped insulating member is disposed in each slot, the insulating member being located between the coils that are adjacent to each other in the circumferential direction in the slot,
at least one of the insulating members includes a thermistor insertion hole that opens in an end face at an end in a lengthwise direction of the insulating member, and
the thermistor is held by the corresponding insulating member in a state of being inserted in the thermistor insertion hole.

2. The stator for the rotating electric machine according to claim 1, wherein a space between the thermistor and an inner surface of the insulating member that defines the thermistor insertion hole is filled with a plastic.

3. The stator for the rotating electric machine according to claim 1, wherein
the thermistor includes:
a sensor unit configured to measure the temperature of the corresponding coil; and
a lead wire extending from the sensor unit,
the insulating member that includes the thermistor insertion hole includes a hole bottom surface that faces in a direction opposite to an insertion direction of the thermistor into the thermistor insertion hole, and
the sensor unit is configured to protrude from the end face of the insulating member by a predetermined length when the sensor unit is inserted in the thermistor insertion hole and brought into contact with the hole bottom surface.

4. The stator for the rotating electric machine according to claim 1, wherein
each tooth includes:
a tooth extension extending from the inner circumferential surface of the yoke; and
two flanges projecting from a distal end of the tooth extension toward opposite sides in the circumferential direction of the yoke,
the insulating members each include a supported surface that extends over a slot opening, the slot opening being a gap between ones of the flanges adjacent to each other in the circumferential direction, the supported surface being supported by both of the flanges that are adjacent to each other in the circumferential direction,
the supported surface includes a recess that is open toward the slot opening,
the recess of the insulating member that includes the thermistor insertion hole is continuous with the thermistor insertion hole, and
the recesses are filled with a plastic that has a higher thermal conductivity than the insulating members.

5. The stator for the rotating electric machine according to claim 4, wherein
each of the insulating members includes:
a first coil supporting surface that supports one of the two coils that are adjacent to each other in the circumferential direction in the corresponding slot; and
a second coil supporting surface that supports the other one of the two coils that are adjacent to each other in the circumferential direction in the corresponding slot, and
the first coil supporting surface and the second coil supporting surface each include a connection hole that connects the recess and the slot to each other.
